(19) United States
(12) Patent Application Publication
(10) Pub. No.: US 2006/0242359 A1
(43) Pub. Date: Oct. 26, 2006

(54) Data storage device

(76) Inventor: Pascal Bancsi, Van Der Marckstraat (NL)

Correspondence Address: GOODWIN PROCTER LLP;PATENT ADMINISTRATOR, EXCHANGE PLACE, BOSTON, MA, 02109-2881, US

(21) Appl. No.: 10/559,196

(22) PCT Filed: Jun. 1, 2004
(86) PCT No.: PCT/IB04/02029

§ 371 Date: May 30, 2006

(30) Foreign Application Priority Data
Jun. 2, 2003 (GB) 0312569.7

(51) Int. Cl. G06F 13/00

(52) U.S. Cl. 711/113

(57) ABSTRACT

The invention provides an IDE or ATA or serial ATA or other standard interface device (30) for facilitating storage of data in a computer. The computer includes a drive controller (20) for generating commands for controlling the reading of data from and writing of data to a data storage medium such as a hard disk. The interface device comprises a RAM drive controller(34) configured to cause data to be written to/read from a RAM (32) in response to the drive controller commands, whereby the data is stored in the RAM.

The present invention relates to a data storage device for a computer and to a method of storing data.

A computer, as referred to herein, is any machine that uses memory for electronic storing of data. Thus, for example, a computer may be a personal computer (PC) or a microprocessor device or a TV set-top box or an arcade game machine or a digital electronic device.

Computers (e.g. PCs) normally include magnetic data storage media such as hard disks. The hard disk forms part of an Advanced Technology Attachment (ATA), otherwise known as an Integrated Drive Electronics (IDE), device which also includes components that control the reading and writing of data from and to the hard disk. Devices of this type have become standard in the computer industry.

Hard disks are limited in performance by their mechanical construction. In particular the maximum rotational speed of a commercially available hard disk platter is 15,000 rpm. The mechanical limitations of a hard disk limit the minimum random access time for data input/output (I/O) to around 8 milliseconds. This compares with minimum random access times for data I/O in the case of a Dynamic Random Access Memory (DRAM), which are measured in microseconds.

Historically, it has been commercially expensive and technically difficult to produce a viable alternative for a hard disk using RAM, such as DRAM. It is known to create expensive Solid State Disks. These use DRAM for data storage, but possess integral hard disk components for permanent data storage and use SCSI or fibre channel interfaces for communications between the DRAM and hard disk and with the computational system. Dedicated software or firmware is also required for transferring data from the integral hard disk to the DRAM. These devices are expensive, costing around $10,000 per Gigabyte of storage.

It is an aim of the present invention to provide a device and associated method for data storage that alleviates the aforementioned limitations.

It is a further aim of the present invention to facilitate use of DRAM (SDRAM or DDRAM) as the principal or as an alternative data storage medium in a PC. It is a further aim to provide a means to do this economically.

According to a first aspect of the present invention there is provided an IDE or ATA or serial ATA or other standard interface device for facilitating storage of data in a computer, the computer including a drive controller for generating commands for controlling the reading of data from and writing of data to a data storage medium such as a hard disk, the device comprising a RAM drive controller configured to cause data to be written to/read from a RAM in response to said drive controller commands, whereby said data is stored in said RAM.

The interface device may comprise a serial attached SCSI or a PCI Express bus.

Preferably the interface device includes the RAM. The RAM may be a DRAM, SDRAM or DDRAM.

It is an advantage that, in embodiments of the invention, the device stores data in DRAM instead of or in addition to an integral hard disk. The DRAM emulates a hard disk, and appears to the computer's operating system to be a hard disk. For this reason it is referred to as a DRAM disk, although it does not have the appearance or the mechanical characteristics of a conventional hard disk. The device behaves as an IDE device and appears to the computer system to be an IDE device with a hard disk, but in fact contains no mechanical or rotating parts at all.

Preferably, the interface device comprises standard RAM sticks. Conveniently, the interface device is provided with a plurality of slots for accepting the standard RAM sticks. The slots may be DIMM slots.

It is an advantage that the user can determine how much RAM to use and can upgrade the amount of RAM by inserting further RAM sticks into the slots provided, or by replacing a RAM stick with one of larger capacity.

The device may be bootable and may be independent of the computer's operating system or file system.

It is an advantage that a DRAM disk has a much higher I/O per second and lower Random Access Times than magnetic hard disks, but behaves and interfaces with the computer in the same way as a conventional magnetic hard disk. DRAM disks also use less power, generate less heat, and are less fragile than hard disks. They are also completely silent and have much lower failure rates. DRAM Disks have further advantages in that their read and write speeds are identical to each other and are independent of disk fragmentation, making them more predictable than hard disks or Flash RAM disks.

In a preferred embodiment, the device is an Integrated RAM Drive Electronics (IRDE) device further comprising a drive CPU and a power controller for controlling power to device components.

Preferably the RAM drive controller comprises an IDE or ATA or serial ATA or other standard interface controller for receiving said commands and for receiving and transmitting said data and a RAM controller for reading/writing said data from/to said RAM.

It is an advantage that the IRDE device comprises all the components required to completely replicate or substitute for an IDE or ATA or serial ATA device in a computer so that no additional components, connections or configuration of the device are required when installed in a PC.

In an alternative embodiment the RAM may be a non-volatile RAM. Preferably, the non-volatile RAM is flash RAM or Static RAM. More preferably, where the non-volatile RAM is flash RAM, the flash RAM is a compact flash RAM and/or an optical flash RAM. Advantageously, the optical flash RAM may be a very fast optical flash RAM.

It is an advantage that, when using a non-volatile RAM, if the computer is switched off, or power supply is interrupted, the data in the RAM is not lost.

In an alternative embodiment, the interface device further comprises an auto-backup facility whereby data in the RAM is copied to a hard disk in response to a loss of power to the RAM.

Preferably, the autobackup facility comprises a battery operable for providing an auxiliary power supply to the RAM and to the hard disk drive.

Conveniently, the interface device comprises firmware operable for controlling the interface device to perform a copy of the data in the RAM to the hard disk, preferably when the power is lost. Preferably, the firmware is further operable, when power is restored to the device, for checking and, if necessary, copying data from the hard drive back to the RAM.

According to a second aspect of the present invention there is provided a method of reading data from and/or writing of data to a RAM in a computer, the computer having a drive controller for generating commands for controlling the reading/writing of data from/to a data storage medium such as a hard disk, the commands including hard disk addresses, the method comprising:

reading the commands generated by said drive controller;

translating the commands into instructions for reading/writing the data from/to the RAM, wherein the instructions include RAM addresses which are in one to one correspondence with equivalent hard disk addresses; and

reading/writing said data from/to a RAM in accordance with the instructions so that the data is written to/read from the RAM whilst maintaining the functionality of a hard disk.

In a preferred embodiment, wherein the commands involve hard disk sectors, the step of translating comprises linearly mapping hard disk sectors to memory bits of said RAM. The linear mapping may comprise operation of a conversion algorithm.

According to a third aspect of the present invention there is provided a computer comprising:

a drive controller for generating commands for controlling the reading of data from and writing of data to a data storage medium comprising a hard disk;

a RAM array; and

a RAM drive controller configured to cause said data to be written to/read from said RAM in response to said drive controller commands, whereby said data is stored in said RAM.

Embodiments of the invention will now be described by way of example with reference to the following drawings, wherein:

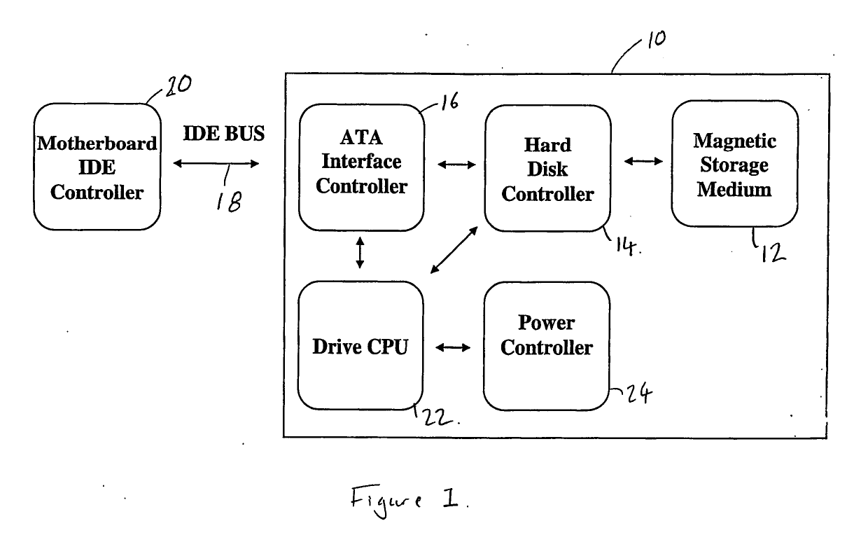

FIG. 1 is a schematic representation of part of a computer including a known device for storing data on a magnetic hard disk; and

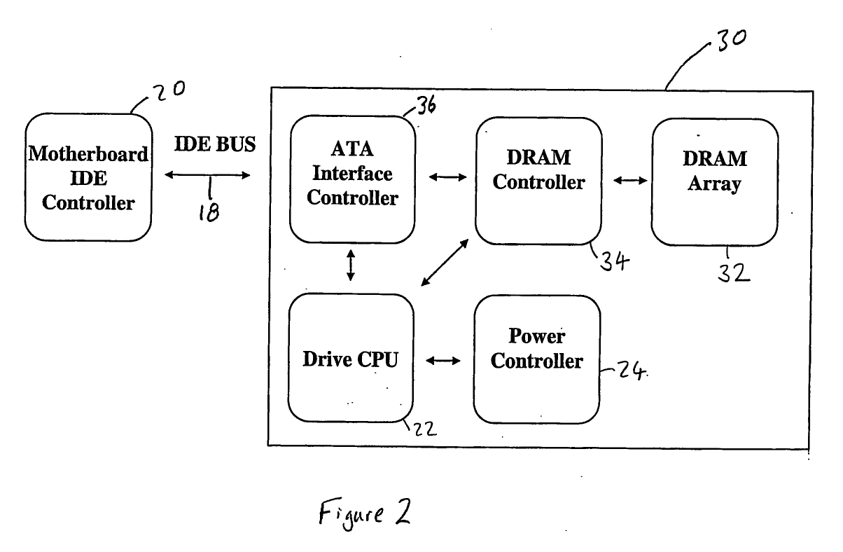

FIG. 2 is a schematic representation of part of a computer including a device for storing data on a DRAM in accordance with the present invention.

Referring to FIG. 1 an Integrated Drive Electronics (IDE) device 10 as conventionally employed in a PC includes a magnetic storage device (hard disk) 12 and a hard disk controller 14 which controls the writing of data to and reading of data from the hard disk 12. The IDE 10 also has an interface controller 16 which is linked by way of an IDE bus 18 to an IDE controller 20 on the PC's motherboard. The interface controller controls the passing of data and associated commands between the IDE controller 20 and the hard disk controller 14. The associated commands include addresses that identify the storage location of data on the hard disk. The IDE further includes a drive CPU 22 that performs the software operations required for the functioning of the hard disk controller 14 and the interface controller 16. Power is provided by way of a power controller 24. Power is required for the functioning of the drive CPU 22, each of the controllers 14, 16, 24 and the mechanical operation of the hard disk 12.

In use, when data is to be stored on the hard disk drive the IDE controller 20 on the PC's motherboard sends a message by way of the IDE bus to the interface controller 16 on the IDE 10. The message contains commands that include address information concerning the location on the hard disk 12 where the data is to be stored, as well as the data itself. The interface controller processes the message according to a set protocol and passes the processed information (commands and data) to the hard disk controller 14. The hard disk controller 14 controls operation of the hard disk 12 in accordance with the instructions and stores (writes) the data onto the hard disk 12.

Reading of data from the hard disk 12 is performed when read commands are passed from the IDE controller 20. The commands are processed by the interface controller 16 and passed to the hard disk controller 14. The hard disk controller 14 controls the hard disk to provide the data, which is then passed back to the IDE controller 20 on the motherboard.

Referring to FIG. 2, the IDE device 10 of FIG. 1 is replaced by an IRDE device 30. The IRDE device 30 is identical to the IDE device 10 of FIG. 1, except that it has a DRAM array 32 in place of the hard disk 12, a DRAM controller 34 in place of the hard disk controller 14, and a revised ATA interface controller 36. All other components are the same as and have the same reference numerals as in FIG. 1. The DRAM array 32 may be DDRAM or SDRAM.

The DRAM is typically provided in the form of standard RAM sticks. The IRDE device is provided with slots, for example DIMM slots for accepting the standard RAM sticks. This means that the user can determine for himself how much RAM he wishes the device to have. He can upgrade the amount of RAM at any date by inserting further RAM sticks into the slots provided. He can also take advantage of higher capacity RAM sticks which may become available.

In the IRDE device30, the revised ATA interface controller 36 is configured to receive the commands and data from the IDE controller 20 on the motherboard, and to process the commands and data into a form suitable for the DRAM controller 34. The DRAM controller 34 then controls the writing of the data to (or reading of data from) the DRAM array 32. The processing of the instructions received from the IDE controller includes converting the hard disk address information into DRAM addresses, as will be described in more detail below.

Thus, as far as the PC's motherboard and operating system are concerned, the IRDE device 30 behaves in exactly the same way as the IDE device 10 of FIG. 1. However, the DRAM array 32 has no moving parts. Data can be written and read at much higher I/O rates because there are no mechanical operations or controls. The absence of mechanical operations eliminates the noise, reduces the power consumption, and lowers the failure rate (i.e. higher mean time between failures—MTBF) associated with hard disk drives.

DRAM is volatile memory and requires a permanent power supply if the data stored is not to be lost. However, the IRDE device uses very little power—around 0.5 Watts per Gigabyte on average. Thus, a 2 GB device would require 200 milliamps and 6.2 volts, and so it is perfectly feasible to leave the IRDE device on all the time. In a PC for example, one would provide a separate 6-12 volt DC power supply for the IRDE device that would remain on even when the PC is turned off. In this way data is only lost when the PC power cord is unplugged or when there is a power cut. These two eventualities can be overcome by the use of a small backup battery, which kicks in when the external power is removed for any reason. The separate power supply and/or the backup battery may be an integral component of the IRDE device. Another option is to employ an uninterruptible power supply (UPS) if required.

Alternatively, the RAM may be a non-volatile RAM, for example flash RAM or Static RAM. Flash RAM is available as a compact flash RAM and also as an optical flash RAM. Recent advances in optical flash RAM technology have resulted in optical flash RAM having very fast read/write speeds. The use of non-volatile RAM means that, when the computer is switched off, or power supply is interrupted, the data in the RAM is not lost.

In another alternative arrangement, the interface device includes an auto-backup facility. If power to the IRDE device is lost, data in the RAM is copied to a hard disk. This is an integral hard disk drive connected via a standard IDE port. A battery is provided, which kicks in when power is lost to provide an auxiliary power supply for the RAM and the hard disk drive. The firmware of the IRDE device then commences a sector by sector copy of the data in the RAM to the hard disk. When this process is finished the battery disconnects to save energy.

When power is restored to the device, the firmware checks the data on the hard disk and in the RAM and, if necessary, performs a sector by sector copy of data from the hard drive back to the RAM.

Operation of the IRDE device includes the conversion of the storage address information passed to the DRAM controller 34 by the revised ATA interface controller 36. The hard disk addresses are converted into DRAM array addresses. The DRAM array behaves to the system as though it were a standard magnetic hard disk having a fixed number of clusters, sectors, cylinders, tracks and heads. In this respect the DRAM array behaves as a Virtual Hard Disk—i.e. it emulates a hard disk.

Depending on the BIOS of the PC; the hard disk addresses may be in LBA (Logical Block Address) format or may be in CHS (Cylinder, Head, Sector) format. Where they are in LBA format the bits and words of the data stored in the DRAM array are linearly mapped on to the sectors of the Virtual Hard Disk which the array is emulating. There is a static 1 to 1 correspondence between memory bits and logical block addressed sectors of the virtual Hard Disk.

Where the format is CHS, the IRDE controller creates CHS (Cylinder, Head, Sector) addresses from the LBA addresses (and vice versa) using a conversion algorithm. CHS Format is limited to

0-1023 Cylinders

0-254 Heads per cylinder

1-63 Sectors per head

so it can support 1024×255×63=16,450,560 sectors. Each sector is 512 bytes. The maximum size of a CHS addressed Hard Disk is 8,225,280 KB or just over 8 GB.

But Logical Block Addressing just counts sectors starting at sector 0 and ending at a maximum of 2048 GB (with 512 Byte sectors). To get an LBA address from a CHS address one can use the following formula:
LBA=C×(No of heads per cylinder)×(No of sectors per head)+H×(No of sectors per head)+(S−1)

Generally, older Motherboard BIOSes use the CHS addressing method and newer ones use the LBA method.

The difference between the processes of writing a file to a conventional IDE device and to the IRDE device is described as follows.

Writing a file from system RAM to an IDE hard disk:
a. The file is passed to the Operating System (OS)
b. The OS passes the file to the driver for the motherboard IDE controller 20.
c. The motherboard IDE controller 20 issues the appropriate ATA command to the IDE device 10 to write data to certain logical sectors (the file system is involved in this but it is common to an IDE device 10 and an IRDE device 30).
d. The hard disk controller then positions the write head accordingly and waits for the appropriate sector of the hard disk to move past the head and then streams (writes) the data to the disk.

Writing a file from system RAM to an IRDE device:
a. The file is passed to the OS
b. The OS passes the file to the driver for the motherboard IDE controller 20.
c. The motherboard IDE controller 20 issues the appropriate ATA command to the IRDE device to write data to certain logical sectors
d. The IRDE controller then calculates the DRAM addresses (memory locations) corresponding to the logical sectors that the DRAM storage array is emulating and that the data should be written to. The DRAM controller then streams the data to those memory locations.

Reading a file from an IDE Hard Disk or from an IRDE device is the same process reversed with writing replaced by reading.

1-16. (canceled)

17. An IDE or ATA or serial ATA or other standard interface device for facilitating storage of data in a computer, the computer including a drive controller for generating commands for controlling the reading of data from and writing of data to a data storage medium such as a hard disk, the device comprising a RAM drive controller configured to cause data to be written to/read from a RAM in response to said drive controller commands, whereby said data is stored in said RAM.

18. A device according to claim 17 wherein the interface device includes the RAM.

19. A device according to claim 18 wherein the RAM is a DRAM, SDRAM or DDRAM.

20. A device according to claim 17, wherein the device is bootable.

21. A device according to claim 17 wherein the device is independent of the computer's operating system or file system.

22. A device according to claim 17 further comprising a drive CPU and a power controller for controlling power to device components.

23. A device according to claim 17 wherein the RAM drive controller comprises an IDE or ATA or serial ATA or other standard interface controller for receiving said commands and for receiving and transmitting said data and a RAM controller for reading/writing said data from/to said RAM.

24. A device according to claim 17, further including a power supply for providing power to said RAM.

25. A device according to claim 24 wherein the power supply is a backup power supply.

26. A method of reading data from and/or writing of data to a RAM in a computer, the computer having a drive controller for generating commands for controlling the reading/writing of data from/to a data storage medium such as a hard disk, the commands including hard disk addresses, the method comprising:
reading the commands generated by said drive controller;
translating the commands into instructions for reading/writing the data from/to the RAM, wherein the instructions include RAM addresses which are in one to one correspondence with equivalent hard disk addresses; and
reading/writing said data from/to a RAM in accordance with the instructions so that the data is written/read to/from the RAM whilst maintaining the functionality of a hard disk.

27. A method according to claim 26 wherein the commands involve hard disk sectors, the step of translating comprises linearly mapping hard disk sectors to memory bits of said RAM.

28. A method according to claim 27 wherein the linear mapping comprises operation of a conversion algorithm.

29. A computer comprising:
a drive controller for generating commands for controlling the reading of data from and writing of data to a data storage medium comprising a hard disk;
a RAM array; and
a RAM drive controller configured to cause said data to be written to/read from said RAM in response to said drive controller commands, whereby said data is stored in said RAM.

30. A computer according to claim 29, further including a separate power supply for the IRDE device, which power supply remains on even when the computer is turned off.

31. A computer according to claim 29 further comprising a backup battery.

32. A computer according to claim 29 further including an uninterruptible power supply.
